(19) United States
(12) Patent Application Publication
(10) Pub. No.: US 2005/0182513 A1
(43) Pub. Date: Aug. 18, 2005

(54) Product storing and dispensing system

(76) Inventors: Lawrence Germano Ponsi, Wheeling, IL (US); Robert Panek, Huntley, IL (US); Paul Hanifl, Barrington Hills, IL (US)

Correspondence Address: BARNES & THORNBURG, P.O. BOX 2786, CHICAGO, IL, 60690-2786, US

(21) Appl. No.: 10/780,429

(22) Filed: Feb. 17, 2004

(51) Int. Cl. G07F 11/00; G06F 17/00

(52) U.S. Cl. 700/231

(57) ABSTRACT

A product storing and dispensing system for a multiplicity of items, such as packages of disposable washcloths. The system has a cabinet with a plurality of product compartments in which the temperature is controlled. A sensor is provided in each product compartment for sensing the presence of a product in the compartment. An aging indicator is associated with each of the product compartments, with each aging indicator having multiple product condition signals which can be selectively activated.

### BACKGROUND OF THE INVENTION

This invention relates to product storing and dispensing systems, and in particular to a product storing and dispensing system having a plurality of product compartments, each of which has an aging indicator having multiple product condition signals.

In patient bathing systems, such as that of U.S. Pat. No. 5,956,794, multiple washcloths are contained in a sealed package, with the washcloths being impregnated with a cleansing solution. In normal use, the package is heated so that the washcloths are at a comfortable temperature for body cleansing.

In the past, packages of the bathing system of the '794 patent have been heated in various manners, such as microwave heating, storage in a heated container, or similar means. Multiple problems have been encountered. For example, the temperature of the washcloths is not easily controlled or known. Also, the age of the package typically is not known, and when multiple packages are stored together in some heating arrangement, often the newest packages are taken first, leaving older packages behind, when the oldest packages should be dispensed first to maintain freshness and quality of the washcloths.

### SUMMARY OF THE INVENTION

The invention is directed to a product storing and dispensing system, comprising a cabinet having a plurality of product compartments. A temperature controller is provided for regulating temperature in the cabinet. A sensor is provided for each product compartment for sensing the presence of a product in the product compartment. A processor, connected to each sensor, is configured to accept signals from the sensors. An aging indicator is associated with each product compartment and is connected to the processor, each aging indicator having multiple product condition signals. Means is provided in the processor for selectively activating the multiple product condition signals of each aging indicator.

In accordance with the preferred form of the invention, the temperature controller comprises a thermocouple. In one form of the invention, each sensor comprises an optical detector. In another form of the invention, each sensor comprises an infrared detector.

The aging indicator preferably comprises at least three displays, each display having a different one of the multiple product condition signals. It is preferred that the displays comprise visual indicators. In the disclosed form of the invention, the three displays comprise a first display indicating that a product is not ready for dispensing, a second display indicating that a product is ready for dispensing, and a third display indicating that a product should be selected first for dispensing.

When the product storing and dispensing system is used for maintaining the temperature of products stored therewithin, the cabinet includes a heat source. The heat source preferably comprises a heater which is controlled by the processor.

The cabinet has the product compartments oriented in at least one column. Preferably, there are multiple columns, each of the columns being accessible through cabinet doors.

### BRIEF DESCRIPTION OF THE DRAWINGS

The invention is described in greater detail in the following description of an example embodying the best mode of the invention, taken in conjunction with the drawing figures, in which:

FIG. 1 is a perspective view of one form of a product storing and dispensing system according to the invention;

FIG. 2 is a front perspective view of the product storing and dispensing system of FIG. 1, with the cabinet doors open;

FIG. 3 is a front elevational view of the cabinet of FIGS. 1 and 2, with the left cabinet door omitted to show internal detail

FIG. 4 is an enlarged view of the upper left corner of the cabinet of FIG. 3, to show additional detail; and

FIG. 5 is an exploded schematic illustration of one column of the cabinet of the product storing and dispensing system according to the invention, showing various components thereof.

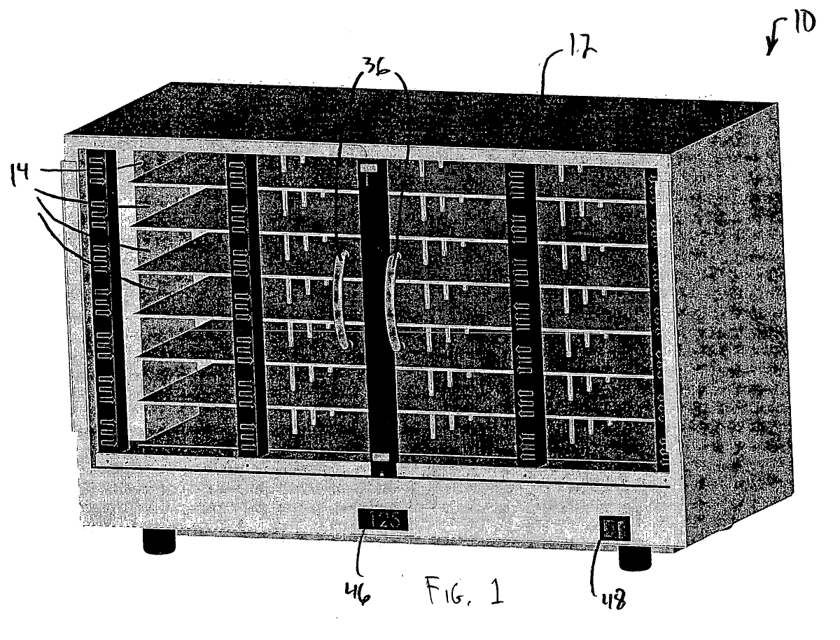

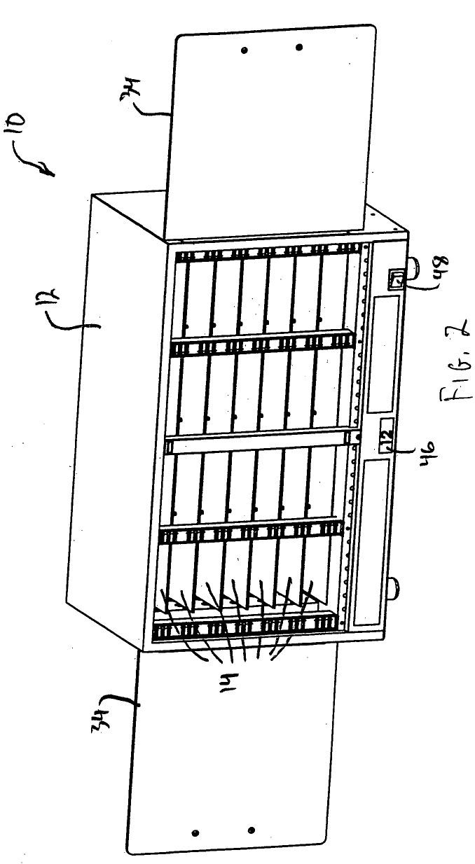

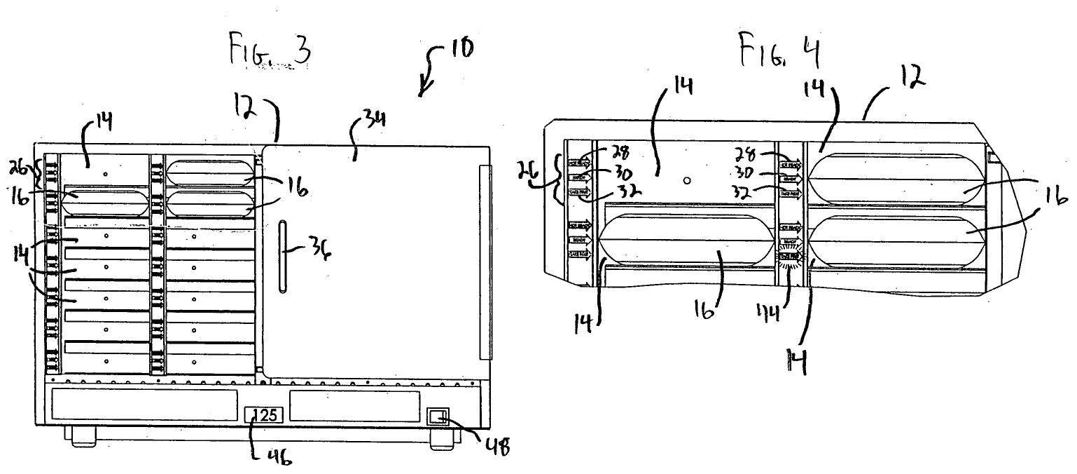

### DESCRIPTION OF EXAMPLES EMBODYING THE BEST MODE OF THE INVENTION

A product storing and dispensing system according to the invention is illustrated at 10 in the drawing figures. The product storing and dispensing system comprises a cabinet 12 having a plurality of product compartments 14, which preferably are arranged in a series of columns as illustrated, although other configurations will be apparent to one skilled in the art.

In the preferred form of the invention, the cabinet 12 is used for storing and dispensing a plurality of products 16, such as packages of washcloths. The washcloths may be those of U.S. Pat. No. 5,956,794. One package 16, when present, is located in one of the product compartments 14. Preferably, a single package 16, when present, is located in one of the product compartments 14, although with other uses of the system 10, multiple products to be dispensed at one time could be located in a single one of the product compartments 14.

Each of the product compartments 14 includes a sensor 18 for sensing the presence of a product 16 in the associated product compartment 14. One of the sensors 18 is illustrated in FIG. 5, it being understood that one sensor 18 is located appropriately in each compartment to sense product in each of the multiple compartments 14. The sensor 18 can be an optical sensor, with a sensing path 20 across each of the compartments 14. Other types of sensors can be used, as well, and another form of the sensor 18 could be an infrared sensor, or a non-optical device, such as a mechanical switch.

The cabinet 12 includes a heat source 22 for maintaining the cabinet 12 at a desired temperature. Preferably, the heat source 22 comprises a radiant heater 24, which is appropriately controlled, as described below, to maintain the internal environment of the cabinet 12 at a controlled temperature.

An aging indicator 26 is associated with each of the compartments 14. Each of the aging indicators 26 has multiple product condition signals, and in one form of the invention, the multiple product condition signals are visual, comprising three displays 28, 30 and 32. Each of these displays 28 through 32 displays a different one of the multiple product condition signals, as will be evident below.

The cabinet 12 preferably is insulated to maintain a steady internal temperature without excessive heat loss, and for access to the cabinet 12, a pair of doors 34 is mounted in a conventional fashion. While the cabinet 12 illustrated in the drawing figures has four columns of the product compartments 14 and two of the doors 34, any number of columns product compartments 14 can be used, depending on requirements. Each of the doors 34 has a handle 36 for ease of access to the interior of the cabinet 12, and although the doors 34 are preferably transparent for ease of viewing product within the cabinet 12, the doors 34 can be transparent or translucent, as desired.

All of the electrical components of the system 10 are controlled by a processor 38. The processor 38, in a conventional fashion, includes a power supply and central processing unit for controlling the various elements of the invention. The processor 38 can be conventional, and is therefore not illustrated in greater detail.

The processor 38 is connected for controlling activation of the heater 24 of the heat source 22. Temperature within the cabinet 12, while controlled by the processor 38, is detected by a temperature controller 40. Preferably, the temperature controller 40 is a thermocouple, although any type of temperature controller can be used.

The activation of the displays 28 through 32 is also controlled by the processor 38. Preferably the displays 28 through 32 are light emitting diodes (LEDs), with each of the displays 28 through 32 for a product compartment 14 being controlled by a simple LED processor 42 (only one of which is shown in FIG. 5). One of the displays 28 through 32 is activated at a time, as explained immediately below.

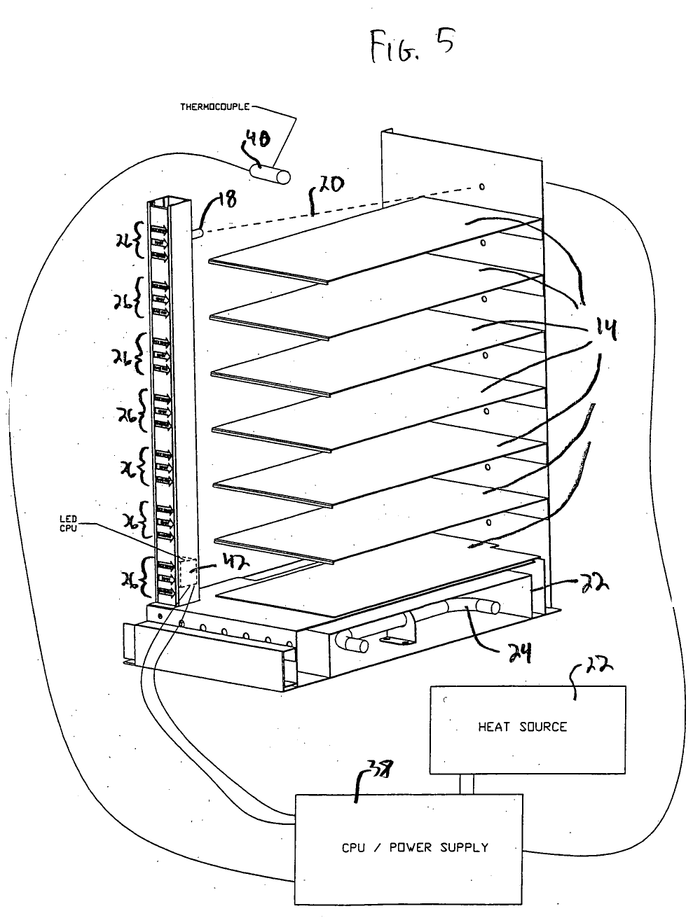

Each of the displays 28 through 32 displays a different product condition. In the illustrated and preferred form of the invention, the display 28 is activated when a product 16 in the associated compartment 14 has not resided in the compartment long enough to be properly heated, and is therefore not ready for dispensing. The second display 30 is activated when the product 16 in the associated compartment 14 is properly heated to a desired temperature and is ready for dispensing. Finally, the third display 32 is activated when the product 16 in the associated product compartment 14 has resided for a sufficiently long period of time that that particular product should be selected first. Thus, as best illustrated in FIG. 4, when the third display 32 is activated, preferably it is activated to draw particular attention of the person or persons utilizing the system 10, such as a flashing display 44. In the preferred form of the invention, the display 28, when illuminated, has a steady illumination as is the display 30, but the display 32 is a flashing display. The three displays together are part of the aging indicator 26, which therefore indicates, visually, the age of a product 16 contained within the associated product compartment 14. The time span over which each of the displays 28 through 30 is illuminated, when a product 16 is in the associated product compartment 14, can be adjusted in the processor 38 in a conventional fashion.

The cabinet 12 may also contain other useful features, such as a temperature display 46 and a power switch 48. Both the temperature display 46 and power switch 48 are obviously connected to the processor 38 in a conventional fashion.

While the invention is illustrated and described with the aging indicator 26 comprising a series of visual displays 28 through 32, in addition to or instead of the displays 28 through 32, other types of indicators, such as audible indicators, can be employed. In addition, the display could be a single display that changes state or indicates a different color for each different age. Also, while the invention is described primarily in connection with maintaining a heated cabinet 12, other environmental conditions can be controlled, as well, such as a cooled cabinet or a cabinet with moisture control.

Various changes can be made to the invention without departing from the spirit thereof or scope of the following claims.

1. A product storing and dispensing system, comprising
a. a cabinet having a plurality of product compartments,
b. a temperature controller for regulating temperature in said cabinet,
c. a sensor for each product compartment for sensing the presence of a product in said product compartment,
d. a processor, connected to each sensor, for accepting sensor signals,
e. an aging indicator associated with each product compartment and being connected to said processor, each aging indicator having multiple product condition signals, and
f. means in said processor for selectively activating the multiple product condition signals of each aging indicator.

2. The product warming system according to claim 1, in which said sensor comprises an optical detector.

3. The product warming system according to claim 1, in which said sensor comprises an infrared detector.

4. The product warming system according to claim 1, in which said aging indicator comprises at least three displays, each display having a different one of said multiple product condition signals.

5. The product warming system according to claim 4, in which said three displays comprise visual indicators.

6. The product warming system according to claim 4, in which said three displays comprise a first display indicating a product is not ready for dispensing, a second display indicating that a product is ready for dispensing and a third display indicating that a product should be selected first for dispensing.

7. The product warming system according to claim 1, including a heat source for said cabinet.

8. The product warming system according to claim 7, in which said heat source comprises a heater controlled by said processor.

9. The product warming system according to claim 1, in which said cabinet includes multiple columns of said product compartments.

10. The product warming system according to claim 1, in which said temperature controller comprises the thermocouple.

11. A product storing and dispensing system, comprising
a. a heated cabinet having a plurality of product compartments,
b. a temperature controller for regulating temperature in said cabinet,
c. a sensor for each product compartment for sensing the presence of a product in said product compartment,
d. a processor, connected to each sensor, for accepting sensor signals,
e. an aging indicator associated with each product compartment and being connected to said processor, each aging indicator having three displays, each display comprising a product condition signal, and
f. means in said processor for selectively activating said displays.

12. The product warming system according to claim 11, in which said sensor comprises an optical detector.

13. The product warming system according to claim 11, in which said sensor comprises an infrared detector.

14. The product warming system according to claim 11, in which said three displays comprise visual indicators.

15. The product warming system according to claim 11, in which said three displays comprise a first display indicating a product is not ready for dispensing, a second display indicating that a product is ready for dispensing and a third display indicating that a product should be selected first for dispensing.

16. The product warming system according to claim 11, including a heat source for said cabinet.

17. The product warming system according to claim 16, in which said heat source comprises a heater controlled by said processor.

18. The product warming system according to claim 11, in which said cabinet includes multiple columns of said product compartments.
